(19) United States
(12) Patent Application Publication
(10) Pub. No.: US 2025/0373562 A1
(43) Pub. Date: Dec. 4, 2025

(54) SYSTEMS, METHODS, AND MEDIA FOR IMPLEMENTING NETWORK CONGESTION CONTROL

(71) Applicant: The Trustees of Columbia University in the City of New York, New York, NY (US)

(72) Inventors: Daniel Rubenstein, New York, NY (US); Vishal Misra, New York, NY (US)

(21) Appl. No.: 19/228,510

(22) Filed: Jun. 4, 2025

Related U.S. Application Data
(60) Provisional application No. 63/656,016, filed on Jun. 4, 2024.

(51) Int. Cl. H04L 47/283; H04L 47/12

(52) U.S. Cl. CPC H04L 47/283; H04L 47/12

(57) ABSTRACT

Mechanisms, including systems, methods, and media, for implementing network congestion control are provided, the methods including: imposing a delay on traffic on a connection between a sender and a receiver; determining a minimum round-trip time for traffic on the connection with the delay imposed; and adjusting the delay imposed on the traffic to an adjusted delay based on a minimum propagation delay goal and the round-trip time. In some of these embodiments, the methods further comprise setting an initial value of the delay to the propagation delay goal. In some of these embodiments, the delay is imposed on an acknowledgment message that is part of the traffic. In some of these embodiments, the adjusted delay is equal to the propagation delay goal minus the minimum round-trip time minus the delay.

### CROSS-REFERENCE TO RELATED APPLICATION

This application claims the benefit of U.S. Provisional Patent Application No. 63/656,016, filed Jun. 4, 2024, which is hereby incorporated by reference herein in its entirety.

### BACKGROUND

Internet congestion control protocols aim to enable fair and high utilization of available bandwidth. Traditional loss-based congestion control protocols often result in “RTT unfairness,” where flows with shorter round-trip times (RTTs) receive more bandwidth. These mechanisms also tend to cause inefficient use of link capacities and buffer-bloat. Recent TCP variants like GOOGLE's BBR, which are delay-based, offer improvements by better utilizing bandwidth but introduce “inverse RTT-unfairness,” where longer RTT flows receive more bandwidth. This can lead to exploitation by receivers who artificially delay acknowledgements to increase their bandwidth share.

Accordingly, new mechanisms for implementing network congestion control are provided.

### SUMMARY

In accordance with some embodiments, mechanisms, including systems, methods, and media, for implementing network congestion control are provided.

In some embodiments, systems for implementing network congestion control are provided, the systems comprising: a memory; and at least one hardware processor coupled to the memory and configured to at least: impose a delay on traffic on a connection between a sender and a receiver; determine a minimum round-trip time for traffic on the connection with the delay imposed; and adjust the delay imposed on the traffic to an adjusted delay based on a minimum propagation delay goal and the round-trip time. In some of these embodiments, the at least one hardware processor is also configured to set an initial value of the delay to the propagation delay goal. In some of these embodiments, the delay is imposed on an acknowledgment message that is part of the traffic. In some of these embodiments, the adjusted delay is equal to the propagation delay goal minus the minimum round-trip time minus the delay. In some of these embodiments, the at least one hardware processor is also configured to: determine whether the adjusted delay meets a threshold; and take an action on the connection in response to determining that the adjusted delay meets the threshold. In some of these embodiments, the threshold is zero milliseconds. In some of these embodiments, the action is to reduce a bandwidth of the connection.

In some embodiments, methods for implementing network congestion control are provided, the methods comprising: imposing a delay on traffic on a connection between a sender and a receiver; determining a minimum round-trip time for traffic on the connection with the delay imposed; and adjusting the delay imposed on the traffic to an adjusted delay based on a minimum propagation delay goal and the round-trip time. In some of these embodiments, the methods further comprise setting an initial value of the delay to the propagation delay goal. In some of these embodiments, the delay is imposed on an acknowledgment message that is part of the traffic. In some of these embodiments, the adjusted delay is equal to the propagation delay goal minus the minimum round-trip time minus the delay. In some of these embodiments, the methods further comprise: determining whether the adjusted delay meets a threshold; and taking an action on the connection in response to determining that the adjusted delay meets the threshold. In some of these embodiments, the threshold is zero milliseconds. In some of these embodiments, the action is to reduce a bandwidth of the connection.

In some embodiments, non-transitory computer-readable medium containing computer executable instructions that, when executed by a processor, cause the processor to perform a method for implementing network congestion control are provided, the method comprising: imposing a delay on traffic on a connection between a sender and a receiver; determining a minimum round trip time for traffic on the connection with the delay imposed; and adjusting the delay imposed on the traffic to an adjusted delay based on a minimum propagation delay goal and the round trip time. In some of these embodiments, the method further comprises setting an initial value of the delay to the propagation delay goal. In some of these embodiments, the delay is imposed on an acknowledgment message that is part of the traffic. In some of these embodiments, the adjusted delay is equal to the propagation delay goal minus the minimum round-trip time minus the delay. In some of these embodiments, the method further comprises: determining whether the adjusted delay meets a threshold; and taking an action on the connection in response to determining that the adjusted delay meets the threshold. In some of these embodiments, the threshold is zero milliseconds.

### BRIEF DESCRIPTION OF THE DRAWINGS

FIG. 1 is a block diagram of a system in accordance with some embodiments.

FIG. 2 is pseudo code of an algorithm in accordance with some embodiments.

FIG. 3 is a flow diagram of a process in accordance with some embodiments.

FIG. 4 is a flow diagram of another process in accordance with some embodiments.

FIG. 5 is another block diagram of a system in accordance with some embodiments.

FIG. 6 is a block diagram of hardware in accordance with some embodiments.

### DETAILED DESCRIPTION

In accordance with some embodiments, mechanisms, including systems, methods, and media, for implementing network congestion control are provided.

In some embodiments, for each of one or more senders, a controlled delay mechanism is provided in a path between the sender's output and its acknowledgement input for each receiver connection to the sender. This controlled delay mechanism can add a controlled delay to the round-trip time of communications on the path, in some embodiments. In some embodiments, the delay mechanism can cause the round-trip time of connections of the sender to be any suitable duration. For example, in some embodiments, the controlled delay can be on the order of tens or hundreds of milliseconds. The amount of controlled delay provided by each controlled delay mechanism can be controlled to provide a target round-trip time on the corresponding path even if an additional delay up to a maximum duration of the controlled delay is added to the path by a receiver, in some embodiments. In some embodiments, the target round-trip time can be set to be the same for each of multiple controlled delay mechanisms. In this way, a sender congestion control mechanism will detect the same delay for each receiver connection that it is controlling, in some embodiments. As such, attempts to gain unfair bandwidth improvements by adding artificial delays can be thwarted, in some embodiments.

In some embodiments, the controlled delay mechanism can delay acknowledgement messages (sometimes referred to as acknowledgements, “ack” messages, or “acks”) sent by a receiver before they are processed by a sender's congestion control algorithm. In some embodiments, the controlled delay mechanism can be provided at the input to an acknowledgement input of the sender. In some embodiments, the controlled delay mechanism can be provided by any suitable hardware, such as a buffer, a controller, a proxy, and/or any other suitable mechanism.

In some embodiments, when the controlled delay is sufficiently large, it complicates receivers' abilities to cheat: small artificial increases in delay will simply get absorbed by the controlled delay mechanism, while large artificial increases in delay can be detected by observing RTTs caused by the large artificial increases in delay that are obviously larger than what occurs in practical communication substrates.

In some embodiments, the controlled delay mechanisms can be implemented with senders implementing any suitable congestion control mechanism, such as GOOGLE's BBR congestion control mechanism.

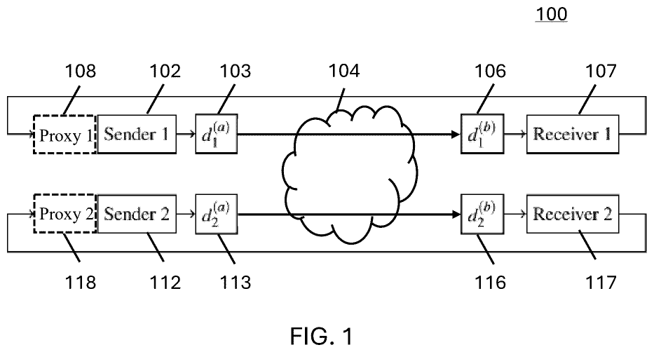

Turning to FIG. 1, an illustration of a system implementing a controlled delay mechanism in accordance with some embodiments is shown.

As illustrated, a sender 102 is connected for communication with a receiver 107. Any suitable information, data, programs, and/or other content, which collectively can be referred to herein as traffic, can be sent from sender 102 to receiver 107. In communicating traffic from the sender 102, the traffic first realizes a delay

$${d}_{1}^{( a )}$$

at 103. This delay can be any suitable delay caused by any suitable mechanism, in some embodiments. In some embodiments, this delay is not intentionally implemented. After 103, the traffic can pass through any suitable network or combination of networks 104. At 106, the traffic experiences another delay

$${d}_{1}^{( b )} .$$

This delay can be any suitable delay caused by any suitable mechanism, in some embodiments. In some embodiments, this delay is not intentionally implemented. Next, the traffic can be received by receiver 107.

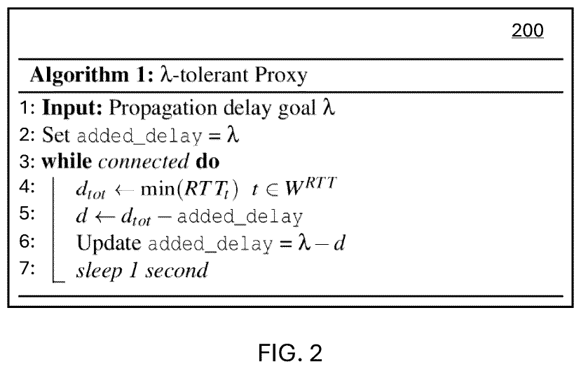

In response to receiving the traffic, receiver 107 can next send one or more acknowledgement messages (and/or any other suitable messages or indicators of receipt of the traffic) back to sender 102. The acknowledgement message can be received by proxy 108 (or any other suitable mechanism) that implements any suitable controlled delay, such as the controlled delays described in below and in connection with FIGS. 2-4. The acknowledgement message can finally be provided to sender 102, whose congestion control mechanism can determine a round-trip time for the traffic based on the time from when it initially sent the traffic to the time it received the acknowledgement message and adjust a bandwidth provided to the connection to receiver 107 based on the determined round-trip time.

In some embodiments, proxy 108 can be implemented in any suitable manner. For example, in some embodiments, proxy 108 can be implemented using a network emulator (netem) queue at the sender's ingress port for the BBR connection. This delays packet acknowledgments at the sender before entering the transport layer and being processed by the sender's congestion control mechanism, in some embodiments.

Sender 112, delay 113, delay 116, receiver 117, and proxy 118 can operate and be implemented similarly or identically to what is described above for sender 102, delay 103, delay 106, receiver 107, and proxy 108, respectively, in some embodiments.

In some embodiments, a delay-based congestion control mechanism, such as GOOGLE's BBR, can be collectively implemented by sender 102 and sender 112 so that the congestion control mechanism provides more bandwidth to receiver 107 than receiver 117 when it observes that receiver 107 is experiencing longer round-trip times, and provides more bandwidth to receiver 117 than receiver 107 when it observes that receiver 117 is experiencing longer round-trip times.

If proxy 108 and proxy 118 were to provide no delay or a fixed, common delay, any relative increase in round-trip time on the path to/from one of receiver 107 and receiver 117 with respect to the path to/from the other of receiver 107 and receiver 117 would cause more bandwidth to be allocated to the path to/from the one of the receivers. While this is a design feature of delay-based congestion control mechanisms when the receivers are acting properly, should one of receivers 107 and 117 artificially add a delay that increases the relative round-trip time of that receiver compared to the other, the delay-based congestion control mechanism would be tricked into unfairly providing extra bandwidth to the receiver artificially adding the delay.

In some embodiments, to address this vulnerability of the delay-based congestion control mechanisms, proxies 108 and 118 can dynamically controlling the delay that they provide in an effort to thwart attempts to get more bandwidth by artificially delay traffic.

FIG. 2 illustrates an example of pseudo code for an algorithm 200 that can be implemented in a controlled delay mechanism, such as proxy 108 and/or 118.

As shown, at line 1, algorithm 200 receives a propagation delay goal λ. This propagation delay goal can have any suitable value, in some embodiments. For example, in some embodiments, the propagation delay goal can have a value on the order of tens or hundreds (e.g., 200) of milliseconds.

Next, at line 2, algorithm 200 sets an added delay provided by the algorithm to the value of the propagation delay goal λ. When the added delay is set, the delay added by the algorithm can thereafter equal the value to which the added delay was set. The added delay can be set in any suitable manner, in some embodiments.

At lines 3-7, algorithm 200 loops through lines 4-7 while the receiver is connected to the sender. The determination of whether the receiver is connected to the sender can be performed in any suitable manner in some embodiments.

At line 4, algorithm 200 sets a variable dₜₒₜ to a minimum round-trip time for the round-trip path from the sender to the receiver and back to the sender. The minimum round-trip time for the path can be determined in any suitable manner, in some embodiments. For example, in some embodiments, the minimum round-trip time for the path can be determined using GOOGLE BBR's ProbeRTT mode. Basing delay equilibrium on propagation delay rather than total packet RTT allows the congestion control mechanism to observe RTT variations caused by congestion induced queuing delay, in some embodiments.

Next, at line 5, algorithm 200 sets a variable d equal to the value dₜₒₜ minus the value of the added delay. Setting variable d can be performed in any suitable manner, in some embodiments.

Then, at line 6, algorithm 200 updates the added delay of the algorithm to be equal to the value of λ minus the value of d. When the added delay is updated, the delay added by the algorithm can thereafter equal the value to which the added delay was updated. The added delay can be updated in any suitable manner, in some embodiments.

Finally, at line 7, algorithm 200 can sleep (or otherwise delay) for any given period of time (e.g., such as 1 second as shown in the figure).

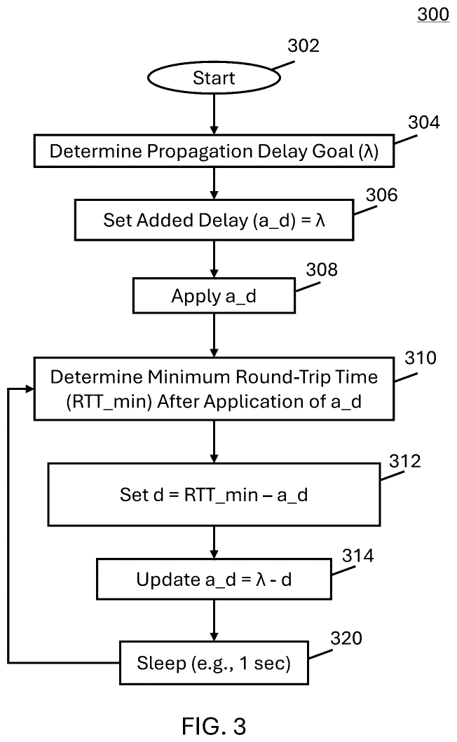

FIG. 3 illustrates algorithm 200 of FIG. 2 in a flow chart format as process 300 in accordance with some embodiments. In some embodiments, process 300 can be implemented in a controlled delay mechanism, such as proxy 108 and/or 118, as described herein.

In some embodiments, process 300 can begin at 302 whenever a connection is established between a sender and a receiver. The process can continue as long as the receiver is connected to the sender, in some embodiments. The determination of whether the receiver is connected to the sender can be performed in any suitable manner, in some embodiments.

After process 300 begins at 302, the process can determine a propagation delay goal 2 at 304. This propagation delay goal can be determined in any suitable manner and have any suitable value, in some embodiments. For example, in some embodiments, the propagation delay goal can have a value on the order of tens or hundreds (e.g., 200) of milliseconds.

Next, at 306, process 300 can set an added delay (a_d) variable to the value of the propagation delay goal λ. This variable can be set in any suitable manner, in some embodiments.

Then, at 308, process 300 can apply the value of variable a_d to set the added delay provided by the controllable delay mechanism. When the added delay is set, the delay added by the controllable delay mechanism can thereafter equal the value to which the added delay was set. The added delay can be set in any suitable manner, in some embodiments.

At 310, process 300 can next determine a minimum round-trip time (RTT_min) for the round-trip path from the sender to the receiver and back to the sender. The minimum round-trip time for the path can be determined in any suitable manner, in some embodiments. For example, in some embodiments, the minimum round-trip time for the path can be determined using GOOGLE BBR's ProbeRTT mode. Basing delay equilibrium on propagation delay rather than total packet RTT allows the congestion control mechanism to observe RTT variations caused by congestion induced queuing delay, in some embodiments.

Then, at 312, process can set a variable d equal to the value of the minimum round-trip time (RTT_min; determined at 310) minus the value of the added delay (variable a_d). Setting variable d can be performed in any suitable manner, in some embodiments.

Next, at 314, process 300 can update the added delay of the controllable delay mechanism to be equal to the value of λ minus the value of d. When the added delay is updated, the delay added by the controllable delay mechanism can thereafter equal the value to which the added delay was updated. The added delay can be updated in any suitable manner, in some embodiments.

At 320, process 300 can then sleep (or otherwise delay) for any given period of time (e.g., such as 1 second as shown in the figure) before looping back to 310.

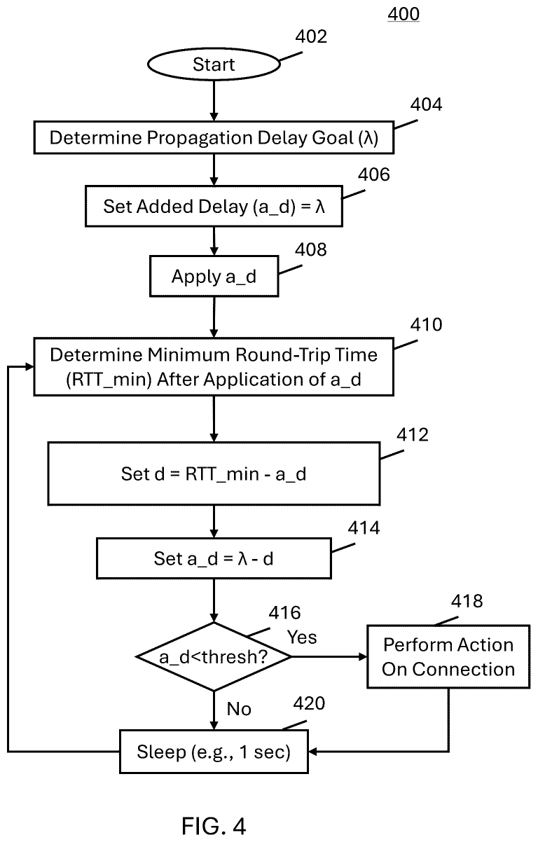

Turning to FIG. 4, a variation 400 of the process of FIG. 3 is illustrated. As shown, process includes blocks 402, 404, 406, 408, 410, 412, 414, and 420, which can be as described for blocks 302, 304, 306, 308, 310, 312, 314, and 320, respectively, of FIG. 3, as described above.

In addition, process 400 can include blocks 416 and 418. As shown, after updating the added delay of the controllable delay mechanism to be equal to the value of λ minus the value of d at 412, process can determine if a_d meets a threshold at 416. Determining if a_d meets a threshold can be performed in any suitable manner in some embodiments. For example, a_d can be determined to meet the threshold when it is less than the threshold, or can be determined to meet the threshold when it is less than or equal to the threshold. Any suitable threshold can be used in some embodiments. For example, a threshold of zero milliseconds can be used in some embodiments. As another example, a threshold of 5 milliseconds can be used in some embodiments. As still another example, a threshold of 10% (or any other suitable percentage) of λ can be used in some embodiments.

If it is determined at 416 that a_d meets the threshold, then, at 418, process 400 can take any suitable action on the connection. For example, in some embodiment, process 400 can terminate the connection, can block the connection, can reduce a bandwidth provided to the connection, can increase bandwidth of other connections, and/or take any other suitable action.

After completing 418, or if it is determined at 416 that a_d does not meet the threshold, process 400 can continue to 420 and proceed as described above in connection with block 320 of FIG. 3.

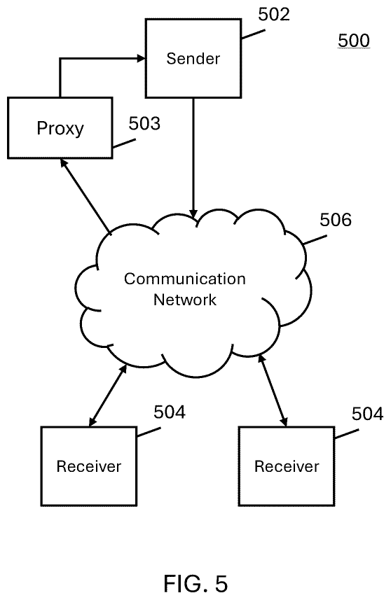

Turning to FIG. 5, an example of hardware on which some embodiments can be implemented is illustrated. As shown, the hardware includes a sender computer 502, a proxy 503, multiple receiver computers 504, and a communication network 506, in some embodiments.

The sending computer, the proxy, and the receiver computers can be any suitable computers, in some embodiments. In some embodiments, the server and the proxy can be combined. In some embodiments, any suitable number of sending computer, the proxy, and the receiver computers can be implemented.

In some embodiments, proxy 503 can implement the algorithm of FIG. 2, the process of FIG. 3, the process of FIG. 4, and/or other algorithm(s)/process(es) that implement some or all of the features of the algorithm of FIG. 2, the process of FIG. 3, and/or the process of FIG. 4.

The communication network can be any suitable communication network or combination of communication networks, in some embodiments. In some embodiments, the communication network can include the Internet, local area network(s), wide area network(s), wired networks, wireless networks, and any suitable components, such as routers, switches, gateways, etc., for implementing same.

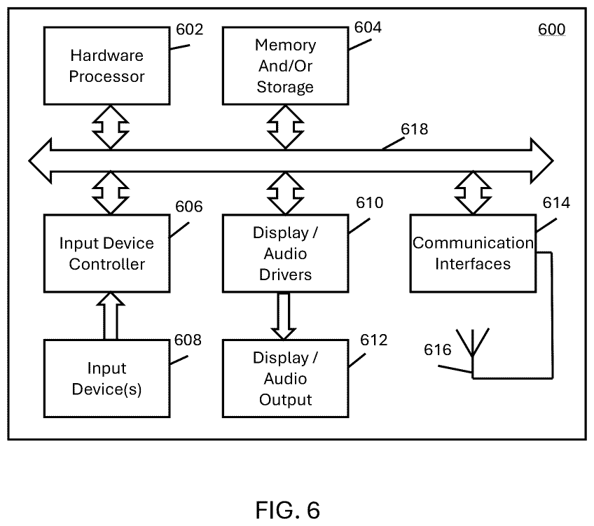

The sending computer, the proxy, and the receiver computers can be implemented in any suitable computing devices. For example, in some embodiments, these components can be implemented using any suitable general-purpose computer or special-purpose computer(s). For example, the components can be implemented in servers, client devices, etc. Any such general-purpose computer or special-purpose computer can include any suitable hardware. For example, as illustrated in example hardware 600 of FIG. 6, such hardware can include hardware processor 602, memory and/or storage 604, an input device controller 606, an input device 608, display/audio drivers 610, display and audio output circuitry 612, communication interface(s) 614, an antenna 616, and a bus 618.

Hardware processor 602 can include any suitable hardware processor, such as a graphical processing unit (GPU), a microprocessor, a micro-controller, digital signal processor(s), dedicated logic, and/or any other suitable circuitry for controlling the functioning of a general-purpose computer or a special purpose computer in some embodiments.

Memory and/or storage 604 can be any suitable memory and/or storage for storing programs, data, and/or any other suitable information in some embodiments. For example, memory and/or storage 604 can include random access memory, read-only memory, flash memory, hard disk storage, optical media, and/or any other suitable memory.

Input device controller 606 can be any suitable circuitry for controlling and receiving input from input device(s) 608, in some embodiments. For example, input device controller 606 can be circuitry for receiving input from an input device 608, such as a keyboard, a mouse, a touch screen, one or more buttons, a voice recognition circuit, a microphone, a camera, an optical sensor, an accelerometer, a temperature sensor, a near field sensor, an automobile navigation system, a global positioning system, and/or any other type of input device.

Display/audio drivers 610 can be any suitable circuitry for controlling and driving output to one or more display/audio output circuitries 612 in some embodiments. For example, display/audio drivers 610 can be circuitry for driving one or more display/audio output circuitries 612, such as an LCD display, a speaker, an LED, or any other type of output device.

Communication interface(s) 614 can be any suitable circuitry for interfacing with one or more communication networks, such as network 506 of FIG. 5. For example, interface(s) 614 can include network interface card circuitry, wireless communication circuitry, and/or any other suitable type of communication network circuitry.

Antenna 616 can be any suitable one or more antennas for wirelessly communicating with a communication network in some embodiments. In some embodiments, antenna 616 can be omitted when not needed.

Bus 618 can be any suitable mechanism for communicating between two or more components 602, 604, 606, 610, and 614 in some embodiments.

Any other suitable components can additionally or alternatively be included in hardware 600 in accordance with some embodiments.

While particular operations and orders of operations are illustrated in FIGS. 1-4, it should be understood that at least some of these operations can be omitted, altered, combined, reordered, supplemented, and executed simultaneously, in some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for implementing network congestion control, comprising:
a memory; and
at least one hardware processor coupled to the memory and configured to at least:
impose a delay on traffic on a connection between a sender and a receiver;
determine a minimum round trip time for traffic on the connection with the delay imposed; and
adjust the delay imposed on the traffic to an adjusted delay based on a minimum propagation delay goal and the round trip time.

2. The system of claim 1, wherein the at least one hardware processor is also configured to
set an initial value of the delay to the propagation delay goal.

3. The system of claim 1, wherein the delay is imposed on an acknowledgment message that is part of the traffic.

4. The system of claim 1, wherein the adjusted delay is equal to the propagation delay goal minus the minimum round trip time minus the delay.

5. The system of claim 1, wherein the at least one hardware processor is also configured to:
determine whether the adjusted delay meets a threshold; and
take an action on the connection in response to determining that the adjusted delay meets the threshold.

6. The system of claim 1, wherein the threshold is zero milliseconds.

7. The system of claim 1, wherein the action is to reduce a bandwidth of the connection.

8. A method for implementing network congestion control, comprising:
imposing a delay on traffic on a connection between a sender and a receiver;
determining a minimum round trip time for traffic on the connection with the delay imposed; and
adjusting the delay imposed on the traffic to an adjusted delay based on a minimum propagation delay goal and the round trip time.

9. The method of claim 8, further comprising setting an initial value of the delay to the propagation delay goal.

10. The method of claim 8, wherein the delay is imposed on an acknowledgment message that is part of the traffic.

11. The method of claim 8, wherein the adjusted delay is equal to the propagation delay goal minus the minimum round-trip time minus the delay.

12. The method of claim 8, further comprising:
determining whether the adjusted delay meets a threshold; and
taking an action on the connection in response to determining that the adjusted delay meets the threshold.

13. The method of claim 8, wherein the threshold is zero milliseconds.

14. The method of claim 8, wherein the action is to reduce a bandwidth of the connection.

15. A non-transitory computer-readable medium containing computer executable instructions that, when executed by a processor, cause the processor to perform a method for implementing network congestion control, the method comprising:
imposing a delay on traffic on a connection between a sender and a receiver;
determining a minimum round trip time for traffic on the connection with the delay imposed; and
adjusting the delay imposed on the traffic to an adjusted delay based on a minimum propagation delay goal and the round trip time.

16. The non-transitory computer-readable medium of claim 15, wherein the method further comprises setting an initial value of the delay to the propagation delay goal.

17. The non-transitory computer-readable medium of claim 15, wherein the delay is imposed on an acknowledgment message that is part of the traffic.

18. The non-transitory computer-readable medium of claim 15, wherein the adjusted delay is equal to the propagation delay goal minus the minimum round-trip time minus the delay.

19. The non-transitory computer-readable medium of claim 15, wherein the method further comprises:
determining whether the adjusted delay meets a threshold; and
taking an action on the connection in response to determining that the adjusted delay meets the threshold.

20. The non-transitory computer-readable medium of claim 15, wherein the threshold is zero milliseconds.
